(19) United States
(12) Patent Application Publication
(10) Pub. No.: US 2025/0241332 A1
(43) Pub. Date: Jul. 31, 2025

(54) A PROCESS FOR PRODUCING A TEA PRODUCT

(71) Applicant: Ekaterra Tea Manufacturing USA LLC, WIlmington, DE (US)

(72) Inventors: Deepak Ramachandra Mhasavade, Bangalore (IN); Vadivel Govindasamy, Bangalore (IN); Anjaneyulu Pendem, Bangalore (IN); Ravi Shankar Audichya, Banagalore (IN); Sreeramulu Guttapadu, Bangalore (IN); Payal Gupta, Bangalore (IN)

(21) Appl. No.: 18/853,352

(22) PCT Filed: Mar. 30, 2023
(86) PCT No.: PCT/EP2023/058254

§ 371 Date: Oct. 1, 2024

(30) Foreign Application Priority Data
Apr. 1, 2022 (EP) 22166356.0

(51) Int. Cl. A23F 3/10; A23F 3/12; A23F 3/14

(52) U.S. Cl. CPC A23F 3/10; A23F 3/12; A23F 3/14

(57) ABSTRACT

The present invention relates to a process of producing a tea product. More particularly the present invention relates to a process of producing a cold-water infusible leaf tea product with rich red colour. Accordingly, the present invention provides a process for producing a tea product comprising the steps of contacting tea leaves with 0.1 to 10% by weight of a base for about 30 minutes to 6 hours.

### FIELD OF THE INVENTION

The present invention relates to a process for producing a tea product. More particularly the present invention relates to a process for producing a cold-water infusible leaf tea product with rich red colour.

### BACKGROUND OF THE INVENTION

Tea is one of the most popular beverages in the world. There are varieties of tea available in the market e.g., black tea, green tea, oolong tea, white tea, etc. Out of these, black tea is most prevalent. One hand, black tea can be consumed with or without milk as a hot beverage. On the other hand, black tea also can be consumed at room temperature or as a cold beverage. There are varied practices between the consumers of different part of the world.

Black tea is predominantly characterized by its rich red coloured infusion. One of the problems associated with black tea beverages prepared in cold water is that the tea infusion lacks colour. This is because tea solids which are responsible for rich red coloured tea infusions are soluble only at high temperature. Therefore, a reduction in the brewing temperature results in lower solubility of the solids that are responsible for colour generation.

There is prior art, which discloses cold water infusible tea products and their characteristics.

WO 00/47056 (Unilever, 2000) discloses leaf product which brews in cold water to produce an iced tea beverage with the color and flavor of iced teas prepared by hot brewing methods. The product when brewed in water at about 15° C. for about 5 minutes at a water to tea ratio of 100 water to 1 tea has a cold water infusion Hunter L Value of about 25 to 45; a Hunter “a” value of about 24 to 34; a Hunter haze value of less than 40 and at least 0.15% soluble tea solids.

U.S. Pat. No. 4,051,264 (Thomas J. Lipton, Inc., 1977) discloses cold water extractable tea leaf prepared by treatment of fresh green tea with the enzyme tannase under anaerobic conditions. This prior art particularly discloses a process wherein fresh tea leaf is subjected to withering, followed by comminution and then tannase is added along with KOH. After this, the fermentation stage is done under covered condition (anaerobic).

Although few prior arts disclose improving the colour of cold-water extractable tea, we found that the resulting colour of the cold-water extractable tea may further be improved. In addition, use of enzymes, in particularly tannase, results in enhancement of the acidity of the tea product because of production of free gallic acid because of tannase treatment.

Tea is also a cheap product with a relatively low profit margin. For this reason, the processing of tea needs to be both cheap and easily implementable.

Therefore, there is a need to provide a cold-water infusible tea product that provides an infusion with enhanced red colour, but also at a low cost using cheap and readily available materials.

The present inventors have surprisingly found out that a process comprising a treatment with selected bases and for a particular time frame and at a particular stage is able to provide a cold-water extractable tea product with enhanced and improved red colour. Furthermore, the present inventors also surprisingly found that the resulting tea product also provides enhanced colour in a hot infusion.

Treating teas with bases is generally known. However, treating tea with base is generally used for distinctly different purposes, using different bases, amounts and at different stages of the tea processing procedure to the process identified by the present inventors.

For example, CN107494806 (SANJIANG DONG AUTONOMOUS COUNTY BUYANG TEA IND CO LTD, 2017) discloses processing of tea leaves by treating it with sodium carbonate or baking soda after plucking, followed by washing it with clean water and then carrying out the regular tea processing. This is directed towards removal of pesticides from the tea leaves. This prior art completely silent about enhancement of colour of the tea product.

Thus, the process of the present invention provides a novel solution to the problem of providing a cold-water infusible tea product, at low cost, that provides an infusion with enhanced red colour.

### SUMMARY OF THE INVENTION

Accordingly, in a first aspect there is provided a process for the preparation of a leaf tea product comprising the steps of contacting tea leaves with 0.1 to 10% by weight of a base for about 30 minutes to 6 hours.

In a second aspect there is provided a process for producing a tea product comprising the steps of;
a) providing fresh tea leaves with moisture content of at least 65% by weight;
b) optionally, subjecting the incubated leaf to a step of comminution;
c) adding 1 to 10% by weight of a base to the comminuted tea leaves;
d) fermenting the comminuted tea leaves for about 30 minutes to 6 hours; and
e) drying the fermented tea leaves to obtain the tea product.

In a third aspect there is provided a process for producing a tea product comprising the steps of;
a) providing finished tea product with moisture content of less than 5%;
b) adding 1 to 10% by weight of a base to obtain a mix;
c) incubating the mix for about 30 minutes to 5 hours.

These and other aspects, features and advantages will become apparent to those of ordinary skill in the art from a reading of the following detailed description. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

The disclosure of the invention as found herein will be understood to cover all embodiments as found in the claims and as discussed hereinbelow.

Where a feature is disclosed with respect to a particular aspect of the invention (for example in relation to one specific process of the invention), such disclosure is also to be considered to apply to any other aspect of the invention (for example in relation to any other process of the invention) mutatis mutandis.

The present invention provides a process for producing a tea product comprising the steps of contacting tea leaves with 0.1 to 10% by weight of a base for about 30 minutes to 6 hours.

It will be appreciated that the tea leaves may be fresh tea leaves from a tea plant or a finished tea leaf product.

When the tea leaves are fresh tea leaves, preferably have they a moisture content of more than 30%, preferably more than 50%, still more preferably more than 60%, and most preferably more than 65%.

In certain embodiments, the fresh tea leaves have a moisture content of between 30% and 95%, preferably between 50% and 90%, even more preferably between 60% and 90%, and most preferably between 65% and 85% (e.g. 75% to 80%).

When the tea leaves are a finished leaf tea product, preferably the finished leaf tea product has a moisture content of less than 5%, preferably less than 3%.

In certain embodiments, the finished leaf tea product has a moisture content of between 0.5% and 5%, preferably between 0.5% and 4%, more preferably between 1% and 3%, and most preferably between 1.5% and 2.5%.

Finished leaf tea product preferably means tea leaves which has undergone the tea manufacturing process and are ready for consumption. One of such process is black tea manufacturing process. In black tea manufacturing process fresh tea leaves first undergoes withering. After the withering step, the withered tea leaf undergoes maceration (a process of size reduction) followed by fermentation. After fermentation a drying step is performed to produce a black leaf tea product with less than 5% moisture content.

In one of the embodiments of the present invention the fresh tea leaves with moisture content of more than 65% by weight, is contacted with 0.1 to 10% by weight of a base for about 30 minutes to 6 hours.

The process of contacting includes but not limited to, spraying, dipping, submerging etc. In certain embodiments, the tea leaves are contacted with the base by spraying. Preferably, the contacting time is in the range from 70 minutes to 5 hours, more preferably from 80 minutes to 4 hours and most preferably from 90 minutes to 3 hours.

In certain embodiments, the contacting time is in the range from 70 minutes to 3 hours, more preferably from 80 minutes to 3 hours, and most preferably from 80 minutes to 2 hours.

Preferably, the steps of contacting tea leaves with 0.1 to 10% by weight of a base is conducted at a temperature of between 10 and 45° C., more preferably at a temperature of between 15 and 40° C., even more preferably at a temperature of between 20 and 35° C., and most preferably at a temperature of between 20 and 30° C. (e.g. 25° C.).

In an alternate embodiment of the present invention the macerated tea leaves are contacted with 0.1 to 10% by weight of a base for about 30 minutes to 6 hours. These macerated tea leaves are preferably produced by comminuting fresh tea leaves with moisture content of more than 65% by weight.

In yet another embodiment of the present invention preferably finished leaf tea products with moisture content of less than 5% by weight are contacted with 0.1 to 10% by weight of a base for about 30 minutes to 6 hours.

In the most preferred embodiment, the tea leaves are contacted with 0.1 to 10% by weight of a base directly before or during fermentation. That is, for example, there is no step of washing between the contacting the tea leaves with base and fermentation. In certain embodiments, the tea leaves are contacted with 0.1 to 10% by weight of a base during fermentation. That is, the base is present during the fermentation step.

The base used in the process of the present invention preferably has a pKb value greater than 3.75 more preferably greater than 4.68, even more preferably greater than 5, and furthermore preferably greater than 5.5. The pKb value of the base preferably in the range from 3-9, more preferably 3.75-9, still more preferably 4.68-9, yet more preferably 5-9 and most preferably from 5.5-9 (e.g. 6-8.5).

It will be understood that pKb refers to a measure of the alkalinity of a base. That is, pKb refers to the negative base-10 logarithm of the base dissociation constant (Kb). PKb values are well-known and widely cited in the art as a measure of the strength of a base.

It will also be appreciated that the pKb values referenced herein refer to pKb values measured at ambient conditions (e.g. 25° C. and 1 atmosphere).

In certain embodiments, the base is a carbonate or bicarbonate. Preferably the base is selected from sodium carbonate, sodium bicarbonate, potassium carbonate, potassium bicarbonate and mixtures thereof. The most preferred base is potassium bicarbonate.

In certain embodiments, the base is not a hydroxide (e.g. potassium hydroxide).

In some embodiments, the base is not ammonium bicarbonate.

The amount of base is in the range from 0.1 to 10%, preferably 1 to 8%, more preferably 1 to 6%, still more preferably 1 to 5%, even more preferably 1 to 3%, and most preferably 1 to 2.5% (e.g. 1-2%) by weight.

In certain embodiments, the amount of base is in the range from 2 to 8% and suitably 3 to 7% by weight.

In some embodiments, the amount of base is in the range from 0.1 to 3%, suitably 0.5 to 2.5%, and most suitably 1 to 2% by weight.

It will be appreciated that the % by weight of base corresponds to the % based on the dry weight of the tea leaves (e.g. the dry weight of the fresh tea leaves or finished leaf tea product).

In some embodiments, the process of the invention also includes a step of contacting the tea leaves with 0.1 to 5% by weight of a polysaccharide degrading enzyme.

It will be understood that the polysaccharide degrading enzyme may be any enzyme capable of degrading polysaccharides (e.g. pectin, cellulose, hemicellulose etc.) found in the tea leaves. Non-limiting examples of polysaccharide degrading enzymes include pectinases, cellulases, hemicellulases, xylanases and beta-glucanases.

Preferably, the polysaccharide degrading enzyme is a pectinase or a cellulase. Most preferably, the polysaccharide degrading enzyme is a pectinase.

In certain embodiments, the polysaccharide degrading enzyme is a pectinase (e.g. polygalacturonase) in combination with one or more other polysaccharide degrading enzymes selected from cellulases, hemicellulases, xylanases and beta-glucanases.

Examples of suitable pectinase enzymes include polygalacturonase, pectinmthyl esterase, pectin lyase and combinations thereof. Preferably, the pectinase is polygalacturonase.

It will be appreciated, that the tea leaves may be contacted with the polysaccharide degrading enzyme either before, after or in combination with the base, as described herein. Preferably, the tea leaves are contacted with the polysaccharide degrading enzyme before or in combination with the base.

Preferably, the amount of polysaccharide degrading enzyme (e.g. pectinase) is in the range from 0.1 to 5%, more preferably 0.1 to 3%, even more preferably 0.1 to 2%, still more preferably 0.2 to 1.5%, yet more preferably 0.2 to 1%, and most preferably 0.3 to 0.7% by weight.

It will be appreciated that the optional step of adding a polysaccharide degrading enzyme (e.g. pectinase) in combination with the addition of a base is most preferably used for mature tea leaves.

It will be understood that mature tea leaves are tea leaves harvested between 5 and 30 days from the date of last harvest, preferably tea leaves harvested between 7 and 15 days from the date of last harvest, more preferably tea leaves harvested between 10 and 15 days from the date of last harvest.

It will be appreciated that mature tea leaves generally have higher concentrations of fibrous polysaccharide materials such as pectin and cellulose.

In certain embodiments, the process of the invention does not involve the addition of a tannase enzyme.

The present invention also provides a process for producing a tea product comprising the steps of;
a) providing fresh tea leaves with moisture content of at least 65% by weight;
b) optionally, subjecting the tea leaves to a step of comminution;
c) adding 1 to 10% by weight of a base to the comminuted tea leaves;
d) fermenting the comminuted tea leaves for about 30 minutes to 6 hours; and
e) drying the fermented tea leaves to obtain the tea product.

The fresh tea leaf may be obtained from Camellia sinensis var. sinensis and/or Camellia sinensis var. assamica. The moisture content of the fresh tea leaves is at least 65%. Preferably the moisture content of the fresh tea leaves is in the range from 65 to 85%, more preferably from 70 to 85% and most preferably from 70 to 80% by weight.

In a preferred embodiment, step b) is present.

In step b), the fresh tea leaves are subjected to comminution. This step of size reduction is preferably carried out by crushing, tearing and curling (known in the art of tea processing as CTC). One or more CTC steps may be carried out. In this step the leaf breaks up and releases enzymes that exist in the leaf. The comminuted tea leaves also known as dhool.

In embodiments where step b) is absent, the process may comprise a step of creating micropores having diameter in the range of 5 to 100 μm on the fresh tea leaves.

Preferably the micropores have a diameter ranging from 5 to 90 μm, more preferably 20 to 80 μm and most preferably 30 to 70 μm.

The micropores can preferably be created by using a technique selected from the group consisting of lasers, sand blasting, dry ice blasting, micropins, electroporation, and combinations of one or more thereof.

Preferably, the micropores are created using micropins.

The number of micropores is preferably in the range of 200 to 400 per cm² of tea leaf, more preferably 250 to 400 cm² of tea leaf per and most preferably 300 to 400 per cm² of tea leaf.

Preferably, there is an additional step of withering of fresh tea leaves before comminution.

After comminution (step b), there is a step of addition of base. The amount of base is in the range from 0.1 to 10%, preferably 1 to 8%, more preferably 2 to 8% and most preferably 3 to 7% by weight. Preferably the base is selected from sodium carbonate, sodium bicarbonate, potassium carbonate, potassium bicarbonate and mixtures thereof. The most preferred base is potassium bicarbonate.

It will be appreciated that the conditions for the base described in relation to the first aspect of the invention equally apply to all other aspects of the invention.

In step c), the base may be added using any suitable means. Preferably, the base is added in step c) by spraying, dipping or submerging, most preferably base is added in step c) by spraying.

In certain embodiments, the process includes a step of contacting the tea leaves with 0.1 to 5% by weight of a polysaccharide degrading enzyme (e.g. pectinase) before step d).

It will be appreciated that preferred types and amounts of polysaccharide degrading enzyme (e.g. pectinase) are the same as those described hereinabove.

Again, it will be appreciated, that the tea leaves may be contacted with the polysaccharide degrading enzyme (e.g. pectinase, cellulase, hemicellulose and combinations thereof) either before, after or in combination with the base.

Preferably, the tea leaves are contacted with the polysaccharide degrading enzyme (e.g. pectinase, cellulase, hemicellulose and combinations thereof) before or in combination with the base.

After the addition of base (and optionally the polysaccharide degrading enzyme), the comminuted tea leaves undergoes fermentation. Fermentation is preferably carried out by keeping the leaf at a temperature of 10° C. to 60° C. for 30 minutes to 6 hours. Preferably, the temperature of the fermentation is between 25 to 45° C. and more preferably 25 to 40° C. (e.g. 25 to 30° C.). The time for fermentation is preferably 45 minutes to 5 hours, more preferably 1 to 4 hours and most preferably 1 to 3 hours (e.g. 80 minutes to 2 hours).

After fermentation, drying is performed to obtain the tea product of the invention. During the drying step, the fermented dhool is preferably dried to moisture content of less than 10% by total mass of the tea leaf, more preferably less than 5% by total mass of the tea leaf, to obtain the leaf tea product. The drying preferably be performed at a temperature in the range of 80 to 160° C., more preferably 90 to 150° C., most preferably 100 to 130° C.

The drying step is preferably carried out by thermal drying, freeze drying or vacuum drying.

Preferably, the drying step (step e) may be carried out using a fluidised bed drier. More preferably, the drying step (step e) may be carried out using a fluidised bed drier operated at between 90° C. and 150° C. for between 2 to 45 minutes. More preferably, the drying step (step e) may be carried out using a fluidised bed drier operated at between 90° C. and 120° C. for between 2 to 30 minutes. Most preferably, the drying step (step e) may be carried out using a fluidised bed drier operated at between 100° C. and 120° C. for between 5 to 25 minutes (e.g. 20 minutes).

The present invention also provides a process for producing a tea product comprising the steps of;
a) providing a finished leaf tea product with moisture content of less than 5%;
b) adding 1 to 10% by weight of a base to obtain a mix;
c) incubating the mix for about 30 minutes to 6 hours.

Finished leaf tea product preferably means tea leaves which has undergone the tea manufacturing process and ready for consumption. The moisture content of the finished leaf tea product is less than 5%, more preferably less than 4% and most preferably less than 3% by weight.

A base is added to this finished leaf tea product. The amount of base is in the range from 0.1 to 10%, preferably 1 to 8%, more preferably 2 to 8% and most preferably 3 to 7% by weight. Preferably the base is selected from sodium carbonate, sodium bicarbonate, potassium carbonate, potassium bicarbonate and mixtures thereof. The most preferred base is potassium bicarbonate. In certain embodiments, the process includes a step of contacting the tea leaves with 0.1 to 5% by weight of a polysaccharide degrading enzyme (e.g. pectinase) before step c).

It will be appreciated that preferred types and amounts of polysaccharide degrading enzyme (e.g. pectinase) are the same as those described hereinabove.

Again, it will be appreciated, that the tea leaves may be contacted with the polysaccharide degrading enzyme (e.g. pectinase, cellulase, hemicellulose and combinations thereof) either before, after or in combination with the base. Preferably, the tea leaves are contacted with the polysaccharide degrading enzyme (e.g. pectinase, cellulase, hemicellulose and combinations thereof) before or in combination with the base.

The time for incubation of the finished leaf tea product with the base (and optionally also a polysaccharide degrading enzyme) preferably is in the range from contacting time is in the range from 70 minutes to 5 hours, more preferably from 80 minutes to 4 hours and most preferably from 90 minutes to 3 hours.

Incubation is preferably carried out by keeping the finished leaf tea product at a temperature of 10° C. to 60° C. for 30 minutes to 6 hours. Preferably, the temperature of the incubation is between 25 to 45° C. and more preferably 25 to 5 40° C. (e.g. 25 to 30° C.). The time for incubation is preferably 45 minutes to 5 hours, more preferably 1 to 4 hours and most preferably 1 to 3 hours (e.g. 80 minutes to 2 hours).

After incubation, the process may also includer a drying step. The conditions for the drying step are preferably those mentioned hereinabove.

### Optional Additional Steps

It will be appreciated that the processes of the invention may comprise one or more optional additional steps. Such optional steps may include, for example, the addition of one or more additives. A non-limiting list of suitable additives include vitamins, minerals, nutrients, binding agents, buffering agents, sugars, sweeteners, flavourings, bulking agents.

It will be understood that a buffering agent is any agent (compound) which may be added to the composition to maintain the pH of the beverage infusion within a specific range. Preferably, the buffering agent is a compound which can maintain the pH of the tea infusion within the range of 4 to 6, more preferably within a range of 4.5 to 6, still more preferably within a range of 4.8 to 5.8, yet more preferably within a range of 5 to 5.6, and most preferably within a range of 5 to 5.3.

A non-limiting list of suitable buffering agents include citrates, phosphates, borates, glycine and combinations thereof. In certain embodiments, the buffering agent is a basic form of the acid included in the composition of the invention. For example, when the acid is citric acid, the buffering agent may be a citrate (e.g. sodium or potassium citrate).

In certain embodiments, the buffering agent is selected from a citrate, a phosphate or combinations thereof. Suitably, the citrate is a sodium or potassium citrate.

In certain preferred embodiments, the buffering agent is sodium citrate.

A non-limiting list of examples of possible sweeteners include acesulfame K, aspartame, saccharin, sorbitol, stevia, sucralose and xylitol.

A non-limiting list of possible flavourings include vanilla, fruit (e.g. strawberry, lemon, berry), ginger, cardamom, all spices, jasmine and tea essence (e.g. earl grey, black tea).

A non-limiting list of possible nutrients include metal and minerals (e.g. zinc, iron, calcium, sodium, magnesium) and essential fatty-acids (e.g. omega-3 and omega-6). Preferably, the one or more additional nutrients is selected from metals and minerals (e.g. zinc, iron, calcium, sodium), and most preferably iron and/or zinc.

A non-limiting list of possible bulking agents include starch, carboxymethyl cellulose and sugar (e.g. dextrose).

A non-limiting list of possible binding agents include gum arabic, maltodextrin, modified starch and xanthan gum.

It will be appreciated that the one or more additives may be added in any suitable amount. Preferably, the one or more additives are each independently added in an amount of between 0.01 and 5% by weight, preferably between 0.05 and 4% by weight, more preferably between 0.1 and 3% by weight, and most preferably between 0.5 and 2% by weight.

It will be appreciated that the % by weight of base corresponds to the % based on the dry weight of the tea leaves (e.g. the dry weight of the fresh tea leaves or finished leaf tea product).

The processes of the invention may further include a final step of blending the base treated tea product with a non-base treated beverage product of the same type. Preferably, the blend comprises between 1 and 50% of the base treated tea product obtained by the process of the invention by weight of the final tea product. More preferably, the blend comprises between 1 and 40% of the base treated tea product obtained by the process of the invention by weight of the final tea product. Still more preferably, the blend comprises between 1 and 30% of the base treated tea product obtained by the process of the invention by weight of the final tea product. Even more preferably, the blend comprises between 1 and 20% of the base treated tea product obtained by the process of the invention by weight of the final tea product. Yet more preferably, the blend comprises between 1 and 10% of the base treated tea product obtained by the process of the invention by weight of the final tea product. Most preferably, the blend comprises between 2 and 8% of the base treated tea product obtained by the process of the invention by weight of the final tea product.

The present invention will now be demonstrated by way of non-limiting examples below. The examples are for illustration only and do not limit the scope of the invention in any manner.

### EXAMPLES

### Preparation of Different Tea Products

Different tea products were prepared starting from fresh tea leaves obtained from tea plantation in Kenya (Kericho) and using the following procedure:

### Example A

Fresh tea leaves were harvested from a Kenyan tea garden. The moisture content of the tea product was around 78%. After that the tea leaves were withered for between 16-72 hours at a temperature of 25° C. The moisture content of the tea product after withering was 66%. After, the tea leaves were subjected to CTC (cut tear curl) for 4 times to obtain macerated dhool. The macerated dhool was then fermented (exposed to air at 25° C.) for 90 minutes and then dried to a moisture content of less than 5% by weight (at 120-140° C.) to obtain a black leaf tea product.

### Example B

Fresh tea leaves (200 g) were harvested from a Kenyan tea garden. The moisture content of the tea product was around 78%. After that the tea leaves were withered for between 16-72 hours at a temperature of 25° C. The moisture content of the tea product after withering was 66%. After that the tea leaves were immersed in 5% sodium bicarbonate solution (3000 mL) for 60 minutes followed by removing the leaves from the solution and immersed in fresh water for 45 minutes at 25° C. After that the leaves were removed from fresh water and dried to remove surface moisture. Then the leaves were subjected to CTC (cut tear curl) for 4 times to obtain macerated dhool. The macerated dhool was then fermented (exposed to air at 25° C.) for 90 minutes and then dried to a moisture content of less than 5% by weight (at 120-140° C.) to obtain a black leaf tea product.

### Example 1

Fresh tea leaves (200 g) were harvested from a Kenyan tea garden. The moisture content of the tea product was around 78%. After that the tea leaves were withered for 16-72 hours at a temperature of 25° C. The moisture content of the tea product after withering was 66%. Then the leaves were subjected to CTC (cut tear curl) for 4 times to obtain macerated dhool. After that 5% (W/V) sodium bicarbonate solution (40 mL) was sprayed on the dhool and mixed thoroughly. The dhool was then fermented (exposed to air at 25° C.) for 90 minutes and then dried to a moisture content of less than 5% by weight (at 120-140° C.) to obtain a black leaf tea product.

All the above tea products were then brewed using the following protocol.

### Hot Brew

2 g of tea leaves were brewed in 200 mL of distilled water at 95° C. for 2 minutes to prepare infusions.

### Cold Brew

2 g of tea leaves were brewed in 200 mL of distilled water at 25° C. for 2 minutes to prepare infusions.

The colours of the infusions were measured using the following protocol:

### Colour Measurement:

Colour (CIE L*a*b* values) was measured using a Hunter lab Ultrascan XE (Model-USXE/UNI version 3.4, Hunterlab Associates Laboratories Inc. Virginia). A halogen cycle lamp was used as the light source. The illuminant used was D65 and the measurements were made at 10°—Observer angle. Measurements were made using a quartz cuvette of 10 mm path length. Tea infusions as prepared above was filled up to the brim in the cuvette and placed in the instrument for colour measurement. The instrument was calibrated using a standard white tile (Hunterlab Duffuse/8°, mode-RSEX, Port-1″ and area-large) in accordance with the instructions provided in the instructions manual. The L*a*b* values were measured at room temperature (25° C.).

The maximum value for L* is 100, which represents a perfect reflecting diffuser. The minimum is L*=0, which represents black. The a* and b* axes have no specific numerical limits. Positive a* is red and negative a* is green. Similarly, positive b* is yellow and negative b* is blue.

The higher the a* value the redder is the infusion. In the same way the higher the b* value the brighter is the infusion.

The results of these experiments are summarized below in Table 1:

TABLE 1

| | |
|---|---|
| Cold Brew | Hot Brew |

| Example No. | a* | b* | a* | b* |
|---|---|---|---|---|
| A | 2.0 | 31.4 | 6.2 | 70.0 |
| B | 2.3 | 31.9 | 6.4 | 66.8 |
| 1 | 11.2 | 61.3 | 22.3 | 72.4 |

From the above table it is evident that tea product obtained using the process of the present invention (example 1) provides significantly higher a* and b* value when compared to comparative examples (A and B).

Another set of tea products were prepared starting from finished leaf tea product and using the following procedure. For this purposed finished black leaf tea product (fannings grade) was obtained from Kenya.

### Example 2

To 100 g of the finished leaf tea product, potassium bicarbonate solution (2 g of potassium bicarbonate in 150 mL of water) was sprayed. The leaf tea product was then incubated for 2 hours at 24° C. Next, the tea leaf product was dried at 120° C. for 20 minutes to a moisture content of around 3%.

### Example C

Example 2 was compared with the same fannings grade finished black leaf tea product obtained from Kenya, without treatment with base.

Infusions were prepared using the above products and colour was measured using the protocol as described in the previous section.

The results are summarized in Table 2.

TABLE 2

| | |
|---|---|
| Cold Brew | Hot Brew |

| Example No. | a* | b* | a* | b* |
|---|---|---|---|---|
| C | −0.8 | 20 | 11 | 71 |
| 2 | 0.2 | 27 | 22 | 76 |

It is evident that example 2 provides better infusion properties in terms of a* and b* value when compared with Example C.

### Example 3

0.5 g of pectinase enzyme (polygalacturonase) was dissolved in 40 ml of water and the solution (0.5% w/v) was sprayed on to 100 g of a finished leaf tea product obtained from Kenya (2% moisture content). Next, the finished leaf tea product was incubated for 2 hours at 25° C. before being dried at 120° C. for 20 minutes to a moisture content of around 3%.

### Example 4

0.5 g of pectinase enzyme (polygalacturonase) was dissolved in 40 ml of water and the solution (0.5% w/v) was sprayed on to 100 g of a finished leaf tea product obtained from Kenya (2% moisture content). Next, the finished leaf tea product was incubated for 1 hour at 25° C. Next, a potassium bicarbonate solution (2 g of potassium bicarbonate in 150 ml of water) was sprayed onto the leaf tea product and the leaf tea product was incubated for 2 hours at 25° C. Next, the leaf tea product was dried at 120° C. for 20 minutes to a moisture content of around 3%.

### Example C

Examples 2-4 were compared with the same fannings grade finished black leaf tea product obtained from Kenya, without treatment with base or enzyme.

Infusions were prepared using the above products and colour was measured using the protocol as described in the previous section.

The results are summarized in Table 3.

TABLE 3

| | |
|---|---|
| Cold Brew | Hot Brew |

| Example No. | a* | b* | a* | b* |
|---|---|---|---|---|
| C | −0.8 | 20 | 11 | 71 |
| 2 | 0.2 | 27 | 22 | 76 |
| 3 | −0.3 | 25 | 10 | 70 |
| 4 | 0.8 | 31 | 21 | 76 |

It is evident that example 4, that when base and pectinase are administered together, significant improvements to the infusion properties (in terms of a* and b* value) are achieved when compared with both the control and administration of pectinase alone. The improvements in infusion properties for tea products prepared using a base (potassium bicarbonate) and enzyme (pectinase) together are also beneficially significantly better than the improvements achieved using base alone (example 2).

We claim:

1. A process for producing a tea product comprising the steps of contacting tea leaves with 0.1 to 10% by weight of a base for about 30 minutes to 6 hours.

2. A process as claimed in claim 1 wherein the tea leaves are fresh tea leaves with moisture content of more than 65% by weight.

3. A process as claimed in claim 1 wherein the tea leaves are macerated tea leaves.

4. A process as claimed in claim 3 wherein the macerated tea leaves are produced by comminuting fresh tea leaves with moisture content of more than 65% by weight.

5. A process as claimed in claim 1 wherein the tea leaves are finished leaf tea products with moisture content of less than 5% by weight.

6. A process as claimed in claim 1 wherein the tea leaves are contacted with 0.1 to 10% by weight of a base directly before or during fermentation.

7. A process as claimed in any one of the preceding claims wherein the pKb value of the base is greater than 4.68.

8. A process as claimed in any one of the preceding claims wherein the tea leaves are further contacted with a polysaccharide degrading enzyme (e.g. pectinase) before, after or in combination with the base.

9. A process for producing a tea product comprising the steps of;
a) providing fresh tea leaves with moisture content of at least 65% by weight;
b) optionally, subjecting the incubated leaf to a step of comminution;
c) adding 1 to 10% by weight of a base to the comminuted tea leaves;
d) fermenting the comminuted tea leaves for about 30 minutes to 6 hours; and
e) drying the fermented tea leaves to obtain the tea product.

10. A process as claimed in claim 9 wherein there is an additional step of withering of fresh tea leaves.

11. A process as claimed in claim 9 or claim 10 wherein the process comprises an additional step before step d) of contacting the tea leaves with a polysaccharide degrading enzyme (e.g. pectinase) before, after or in combination with the base.

12. A process for producing a tea product comprising the steps of;
a) providing a finished tea product with moisture content of less than 5%;
b) adding 1 to 10% by weight of a base to obtain a mix;
c) incubating the mix for about 30 minutes to 6 hours.

13. A process as claimed in claim 12, wherein the process comprises an additional step before step c) of contacting the tea leaves with a polysaccharide degrading enzyme (e.g. pectinase) before, after or in combination with the base.

14. A process as claimed in any one of the preceding claims wherein the base is selected from sodium carbonate, sodium bicarbonate, potassium carbonate, potassium bicarbonate and mixtures thereof.
